(19) United States
(12) Patent Application Publication
(10) Pub. No.: US 2002/0065317 A1
(43) Pub. Date: May 30, 2002

(54) Calcium salt compositions having improved solubility and method for preparing them

(76) Inventors: Dani Dizer, Rishon-Lezion (IL); Yael Kedem, Moshav Zoor Moshe (IL)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/841,854

(22) Filed: Apr. 25, 2001

Related U.S. Application Data
(63) Continuation of application No. PCT/IL99/00551, filed on Oct. 21, 1999.

(30) Foreign Application Priority Data
Oct. 26, 1998 (IL) 126746

(51) Int. Cl. A61K 31/19; A61K 33/42

(52) U.S. Cl. 514/557; 424/602

(57) ABSTRACT

Calcium composition having improved dissolution rate, which comprises granular agglomerates consisting of elementary granules of at least one calcium salt and at least one wetting agent, forming layers around and between the elementary granules in each agglomerate. The ratio of wetting agent to calcium salt is from 0.1 to 5%. The calcium salt may be a soluble one, chosen from among calcium lactate gluconate and calcium monophopshate, and has a solubility of at least 2 gr/100 ml of water. The wetting agent may be an edible one, chosen from among dioctyl sodium sulphosuccinate, propylene glycol lactostearate, propylene glycol and sodium lauryl sulphate. The size of the elementary granules of calcium salt is less than 50 μm, and preferably less than 30 μm.

### FIELD OF THE INVENTION

This invention relates to powdery compositions based on calcium salts, suitable as dietary auxiliaries for providing a optimal calcium intake, which have a higher dissolution rate, viz. a lower dissolution time, in cold or hot water than the salts themselves, to a process for making them, and to edible products containing them.

### BACKGROUND OF THE INVENTION

Calcium is a major component of mineralized tissues and is required for normal growth and development of the skeleton and teeth. An intake of calcium should be included in the diets of individuals for maximizing peak adult bone mass, maintaining adult bone mass, and minimizing bone loss in an advanced age. The calcium intake that is optimal for these purposes varies through individuals' life time, and is particularly high during the period of rapid growth in the childhood and adolescence, during pregnancy and lactation and in later life. The RDA for calcium is 1000 mg. It is very difficult for individuals to reach this calcium requirement on continuing daily bases. The best way for attaining optimal calcium intake is through appropriate dietary sources. However at the present the dietary intake of calcium of most individuals is well below recommended levels. Therefore, it is desirable to find ways to complement the diet of individuals through the consumption of calcium fortified foods and calcium supplements.

The fortification of calcium is mostly carried out with solid food products, as most calcium salts are difficult to dissolve, especially in cold water. However, fortification of liquid food products and beverages, particularly transparent beverages, like ice-tea, orange and apple juice and carbonated drinks, is rendered difficult by the low dissolution rate of calcium salts.

All calcium salts are difficult to dissolve, especially in cold water. Some salts, like calcium carbonate, citrate, tri- and di-calcium phosphate, are almost impossible to dissolve in cold water. Others, like calcium gluconate, lactate, chloride and monophosphate, are soluble, but the rate of dissolution depends on such factors as the temperature of the water, the particles' size and particles' size distribution, the stirring time and the stirring force applied, and is inadequate for the purpose of using them as additive in liquid foods and beverages.

The art has not found a way of permitting the direct addition of calcium salts to liquid foods and beverages. EP 784 933 A2 discloses a comestible product having an extended release of additives contained therein, wherein the additives are mixed with a carrier containing a microcrystalline material. The comestible product disclosed therein is preferably a gum, either chewing or bubble gum, which may include mineral adjuvants such as calcium salts. This however does not solve the problem of providing a calcium composition that may be directly added to a beverage or other liquid medium and quickly dissolve without producing haziness. Furthermore, the fact that when a calcium salt is used in such a product it is necessarily accompanied by other components which are not required in a diet or are required in amounts unrelated to the amounts of calcium, is an obvious drawback.

It is therefore highly desirable to provide a calcium salt composition which is quickly and completely soluble and can be directly added to liquid food products or beverages in an easily controllable amount.

It is a purpose of this invention to provide such a composition. It is another purpose of this invention to provide a composition in which the calcium salt may be the main component.

It is a further purpose of this invention to provide a calcium salt composition which is quickly and completely soluble in cold and hot water and does not remain suspended therein in solid form, even in part, causing haziness.

It is a still further purpose of this invention to provide a calcium salt composition which is completely soluble in water, even when the water is at room temperature, in a matter of seconds. Such a composition will also be called hereinafter “instantly soluble calcium salt composition” or “powder”.

It is a still further purpose of this invention to provide a method for preparing such a composition.

It is a still further purpose of this invention to provide a method for rendering calcium salts quickly and easily soluble in water.

Other purposes and advantages of this invention will appear as the description proceeds.

### SUMMARY OF THE INVENTION

The instantly soluble calcium composition according to the invention is a granular composition or powder, which comprises granular agglomerates consisting of elementary calcium salt granules and wetting agents. The wetting agents form layers around and between said elementary granules in each agglomerate and bind them together.

The weight ratio of wetting agents to calcium salts generally ranges from 0.1 to 5%, and is preferably about 2%.

The calcium salts are preferably chosen from among salts of inorganic acids, such as calcium monophophate, and salts of organic acids such as calcium lactate gluconate. However any soluble calcium salts can be used, even salts that have a low dissolution rate in the pure state. Calcium salts are considered to be soluble, in the sense in which this term should be construed in the present application, when they have a solubility of at least 2 gr/100 ml of water.

The wetting agents used, must, of course, be edible. Preferred wetting agents are dioctyl sodium sulphosuccinate, propylene glycol lactostearate, propylene glycol and sodium lauryl sulphate, but any edible wetting agent can be used.

The size of the elementary granules of calcium salts should be less than 50 μm and preferably less than 30 μm. The size of the agglomerate granules should be from 50 to 800 μm and preferably from 100 to 425 μm; and they generally contain from 10 to 30 elementary granules. The size of the granules and agglomerates is defined herein by their maximum linear dimension.

The wetting agent coat the elementary granules and bind them together to form the agglomerate granules. The wetting agent coating may cover the entire surface of the elementary granules or of part of them, but generally will cover only a part of said surface.

The composition or powders of this invention can be mixed with other components to constitute edible mixtures, such as ready made soup powders, chocolate and other drinking powders, artificial sweeteners for table top use, and the like. The mixture with other components, no matter in what proportions, does not affect in any way the property of the composition to be quickly soluble. Furthermore, said compositions can be mixed with anti-caking agents to maintain and/or improve their free flowing characteristics.

The process according to the invention comprises adding a calcium salt and a wetting agent and then mixing them. The addition of the wetting agent and the calcium salt is preferably carried out by adding the agent to the salt gradually, while mixing. The mixing is carried out mechanically for a time comprised between 3 and 30 minute, and preferably between 5 and 15 minutes, at temperatures from 10° to 60° C. and preferably from 30° to 400° C., by means of any mixers that are suitable for powder coating, e.g. ribbon mixers, v-cone blenders, matrix mixers, Stephan mixers, truncone mixers and cyclomix.

The invention also comprises, as new products, calcium enriched artificial sweeteners.

### DETAILED DESCRIPTION OF PREFERRED EMBODIMENTS

In order to prepare the granular compositions or powders of the invention, the soluble calcium salt that has been selected is loaded into a mixer and the wetting agent that has been selected is gradually added, thereto while mixing. The following Example 1 illustrates the preparation of an instantly soluble powder according to an embodiment of the invention.

### EXAMPLE 1

Preparation of an Instantly Soluble Calcium Composition

60 gr of Propylene glycol are added gradually to 2 Kg of granular calcium gluconate produced by the Glucona Company (Glucona®Cal). The particle size (maximum linear dimension) distribution of said granular calcium salt was as follows (the indicated percentages being by weight):

less than 10 μm, 45%
10-15 μm, 32%
15-20 μm, 14%
20-30 μm, 7%
more than 30 μm, 2%.

The calcium gluconate and the propylene glycol are then mixed in a Stephan mixer type vm 12 at a speed of 1420 rpm and at a temperature of 30° C.

The dissolution rate of the resulting powder is defined by the dissolution time, viz. the time required fully to dissolve 1 gram thereof into 100 ml of water at 20° C. The dissolution time of the calcium salts compositions of the invention is not more than 60 seconds and preferably not more than 10 seconds. The dissolution time of the powder obtained according to Example 1 is found to be 3.036 sec, while the dissolution time of the untreated calcium gluconate granules is 1.3 minutes, and this only when vigorous stirring is carried out to hasten as much as possible the dissolution. Therefore the powder of Example 1 is an instantly soluble powder, as this expression is to be construed in this, specification.

Table 1 shows how the dissolution rate of powder depends on the length of the mixing time and on the temperature.

TABLE 1

| | | | |
|---|---|---|---|
| Mixing time | 10 minutes | 20 minutes | 50 minutes |

| | | | | | | |
|---|---|---|---|---|---|---|
| Water temperature | 4° C. | 20° C. | 4° C. | 20° C. | 4° C. | 20° C. |
| Dissolution time | 3.79 | 3.036 | 3.93 | 3.284 | 17.526 | 14.046 |
| (sec.) | | | | | | |

An artificial powdered tabletop sweetener, with similar or identical sweetening properties as the existing artificial sweeteners and with high elementary calcium content, can be prepared according to an aspect of this invention. In such a sweetener, fillers such as dextrose, maltodextrine, fructose, lactose and others, normally present in sweeteners, are replaced partially or fully with calcium powders instantly soluble in cold and hot water. In this way, an amount of elementary calcium up to 97 milligrams per sachet of 1 gram of artificial powdered tabletop sweetener, or almost 10% of the Recommended Daily Allowance of calcium intake, can be reached, without causing the sweetening properties of the artificial sweetener to be different from those of a comparable prior art existing artificial sweetener. Calcium salts should be used for this purpose that are neutral in taste in themselves and do not affect the taste of other components in mixtures. The use of Anticaking agents improves the flowing characteristics of the product.

To prepare the improved artificial sweetener, an instantly soluble calcium salt composition, prepared according to Example 1, or any other instantly soluble calcium salt composition according to the invention, is dry blended with an intensive sweetener, an anticaking agent and a filler, in a specific blender for the gentle blending of dry powders granules and crystals such as Thoro and twin blender. Any intensive sweetener can be used, e.g. Aspartamen and Calcium Saccharin. Any anticaking agent to be used, e.g. silicon dioxine, tri-calcium phosphate, calcium silicate, calcium strearate, cellulose, magnesium carbonate, magnesium silicate, magnesium stearate, sodium silicoaluminate. The fillers are those used in the art for this type of products, and may be e.g. dextrose, maltodextrin, soluble fibers, lactose etc.

The proportions of the said component are as follows:

| | |
|---|---|
| Instantly soluble Calcium salt composition | up to 97% |
| Intensive sweetener | 3-4% |
| Anticaking agent | up to 1% |
| Filler | balance |

### EXAMPLE 2

Preparation of an Artificial Sweetener Containing an Instantly Soluble Calcium Composition

In this Example the components used are:

| | |
|---|---|
| Calcium salt composition of Example 1 | 48.95% |
| Calcium Saccharine | 3% |
| Tricalcium phosphate | 0.1% |
| Dextrose | 47.95% |

The components are dry blended for 20 minutes in a small turntable blender, 1 liter volume.

A free flowing artificial sweetener, instantly soluble in hot and cold water, is obtained. It contains 52.2 mg of elementary calcium per 1 gram, equivalent to 5.22% of the Recommended Daily Allowance of calcium.

While embodiments of the inventions have been described by way of illustration, it will be understood that the invention can be carried out with many modifications, variations and adaptations, without departing from its spirit or exceeding the scope of the claims.

1. Calcium composition having improved dissolution rate, which comprises granular agglomerates consisting of elementary granules of at least one calcium salt and at least one wetting agent, forming layers around and between said elementary granules in each agglomerate.

2. Calcium composition according to claim 1, which is a powder.

3. Calcium composition according to claim 1, wherein the ratio of wetting agent to calcium salt is from 0.1 to 5%.

4. Calcium composition according to claim 1, wherein the calcium salt is a soluble one.

5. Calcium composition according to claim 4, wherein the calcium salt is chosen from among calcium lactate gluconate and calcium monophopshate.

6. Calcium composition according to claim 4, wherein the calcium salt has a solubility of at least 2 gr/100 ml of water.

7. Calcium composition according to claim 1, wherein the wetting agent is an edible one.

8. Calcium composition according to claim 7, wherein the wetting agent is chosen from among dioctyl sodium sulphosuccinate, propylene glycol lactostearate, propylene glycol and sodium lauryl sulphate.

9. Calcium composition according to claim 1, wherein the size of the elementary granules of calcium salt is less than 50 μm, and preferably less than 30 μm.

10. Calcium composition according to claim 1, wherein the size of the agglomerate granules should be from 50 to 800 μm, and preferably from 100 to 425 μm

11. Calcium composition according to claim 1, wherein each agglomerate contains from 10 to 30 elementary granules.

12. Calcium composition according to claim 1, having a dissolution time not higher than 60 seconds and preferably not higher than 5 seconds.

13. Calcium composition according to claim 1, wherein the wetting agent forms a coating about the elementary granules and binds them together to form the agglomerate granules.

14. Calcium composition according to claim 13, wherein the coating covers only a part of the surface of the elementary granules.

15. As food products, mixtures of the composition according to claim 1 with other components to constitute edible mixtures.

16. Mixtures according to claim 15, chosen from among ready made soup powders, chocolate and other drinking powders, and artificial sweeteners for table top use.

17. Mixtures according to claim 15, further comprising anti-caking agents.

18. Process for making calcium compositions according to claim 1, which comprises adding a wetting agent and a calcium salt and mixing the same with for a time comprised between 3 and 30 minutes and preferably between 5 and 15 minutes, at temperatures from 10° to 60° C. and preferably from 30° to 40° C.

19. Process according to claim 18, wherein the wetting agent is added to the calcium salt gradually.

20. As new food products, calcium enriched artificial sweeteners containing calcium compositions according to claim 1.
